(19) United States
(12) Patent Application Publication
(10) Pub. No.: US 2007/0209895 A1
(43) Pub. Date: Sep. 13, 2007

(54) Cord reel assembly and vacuum cleaner having the same

(75) Inventors: Jang-keun Oh, Gwangju-city (KR); Sung-tae Joo, Gwangju-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/602,003

(22) Filed: Nov. 20, 2006

(30) Foreign Application Priority Data
Mar. 9, 2006 (KR) 10-2006-0022412

(51) Int. Cl. H02G 11/02

(52) U.S. Cl. 191/12.2 R

(57) ABSTRACT

A cord reel assembly according to the present disclosure includes a power cord; and a cord reel around which the power cord is automatically wound when the power cord is separated from an electric power source, the cord reel from which the power cord is automatically unwound when the power cord connected to the electric power source.

### CROSS-REFERENCE TO RELATED APPLICATIONS

This application claims the priority under 35 U.S.C. §119(a) from Korean Patent Application No. 10-2006-0022412, filed on Mar. 9, 2006, with the Korean Intellectual Property Office, the disclosure of each of which is incorporated herein by reference.

### BACKGROUND OF THE INVENTION

1. Field of the Invention

The present disclosure relates to a cord reel assembly that winds and unwinds a power cord to retract the power cord into the interior or draw the power cord out from the interior of electronic devices, such as vacuum cleaners.

2. Description of the Related Art

Generally, various electronic devices have an electric power supply apparatus thereinside, and the electric power supply apparatus is supplied with electric power from the outside via a power cord.

An end of the power cord is electrically connected to the electric power supply apparatus of the electronic devices, and the other end of the power cord is connected to a plug. When the plug is inserted into an electric outlet of an external power source, the electric power is supplied from the power source to the electric power supply apparatus of the electronic device.

Especially, in case of movable electronic devices such as vacuum cleaners, the power cord is drawn out at the length corresponding to the distance at which the electronic devices moves. When the electronic device is not used, the power cord is made to enter the interior of the electronic device.

A cord reel assembly is disposed inside the electronic device such as vacuum cleaners so as to cause the power cord to easily enter and to easily be drawn out from the electronic device.

The cord reel assembly includes a cord reel configured to wind the power cord using a winding spring, and a drawing out structure unwinding the power cord wound around the cord reel to draw the power cord out of the electronic device.

The drawing out structure includes a roller unwinding the power cord from the cord reel, a driving device driving the roller, and a break device preventing the power cord unwound from the cord reel from being re-wound.

However, with the conventional cord reel assembly, in order to draw out the power cord, users should directly manipulate the drawing out structure. Therefore, it is inconvenient for the users to use the electronic devices with the conventional cord reel assembly.

Also, the conventional cord reel assembly needs many parts so that the process of assembling the conventional cord reel assembly is complicate. As a result, the manufacturing cost of the conventional cord reel assembly is increased.

Furthermore, the conventional cord reel assembly has a complex structure so as to need a large space inside the electronic device. Therefore, the electronic device with the conventional cord reel assembly cannot have a compact size and a pleasing appearance.

### SUMMARY OF THE INVENTION

The present disclosure has been developed in order to overcome the above drawbacks and other problems associated with the conventional arrangement. An aspect of the present disclosure is to provide a cord reel assembly capable of easily winding and/or unwinding a power cord by a simple manipulation.

The above aspect and/or other feature of the present disclosure can substantially be achieved by providing a cord reel assembly, which includes a power cord; and a cord reel around which the power cord is automatically wound and unwound when the power cord is separated from and connected to an electric power source, respectively.

According to an embodiment of the present disclosure, a cord reel assembly includes: a cord reel configured to wind a power cord connected to an electric power supply apparatus of an electronic device; and an unwinding unit electrically connected to the electric power supply apparatus and unwinding the power cord from the cord reel.

The cord reel can include a winding spring rotating the cord reel in a winding direction of the power cord.

The unwinding unit can include: a unwinding roller; a driving motor rotates the unwinding roller in a winding direction of the power cord and electrically connected to the electric power supply apparatus.

The unwinding roller can further include a friction structure on an outer circumferential surface thereof.

The friction structure can include a friction material fixed on the outer circumferential surface of the unwinding roller.

The friction structure can also include a plurality of contacting projections formed from the outer circumferential surface of the unwinding roller.

The cord reel assembly further includes: a contacting unit electrically connected to the electric power supply apparatus and forcing the power cord to be in contact with the unwinding unit.

The contacting unit includes: a pivot frame configured to pivot on a pivot shaft; at least one guiding roller rotatably disposed inside the pivot frame; and a linear motion member configured to pivot the pivot frame so that the power cord is in contact with the unwinding roller.

The linear motion member is electrically connected to the electric power supply apparatus, and has a moving part connected to the pivot frame, wherein the moving part moves upward or downward according as the electric power is applied to the linear motion member.

The linear motion member further includes a solenoid having an electromagnet disposed thereinside and causing the moving part to linearly move by the attraction of the electromagnet.

According to another aspect of the present disclosure, a vacuum cleaner including a cord reel assembly having a cord reel around which a power cord is automatically wound when the power cord is separated from an electric power source, the cord reel from which the power cord is automatically unwound when the power cord connected to the electric power source.

Other objects, advantages and salient features of the disclosure will become apparent from the following detailed description, which, taken in conjunction with the annexed drawings, discloses preferred embodiments of the disclosure.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a view illustrating a cord reel assembly according to an embodiment of the present disclosure having a power cord unwound;

FIG. 2 is a view illustrating a cord reel assembly according to an embodiment of the present disclosure having a power cord wound; and

FIG. 3 is a view illustrating a cord reel assembly according to an embodiment of the present disclosure disposed inside a vacuum cleaner.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined in the description, such as a detailed construction and elements thereof, are provided to assist in a comprehensive understanding of the disclosure. Thus, it is apparent that the present disclosure may be carried out without those defined matters. Also, well-known functions or constructions are omitted to provide a clear and concise description of exemplary embodiments of the present disclosure.

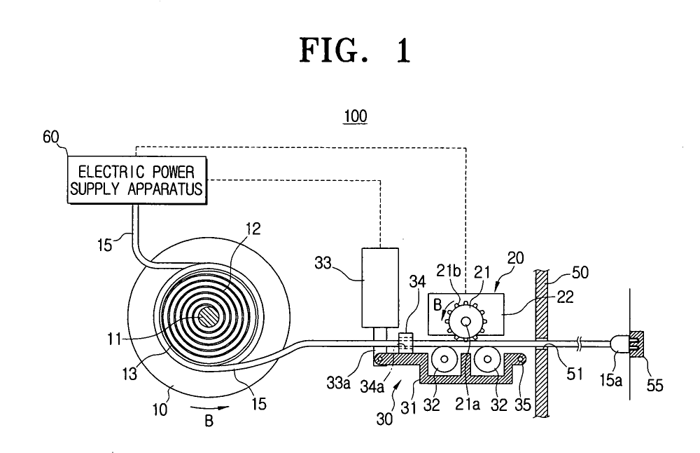

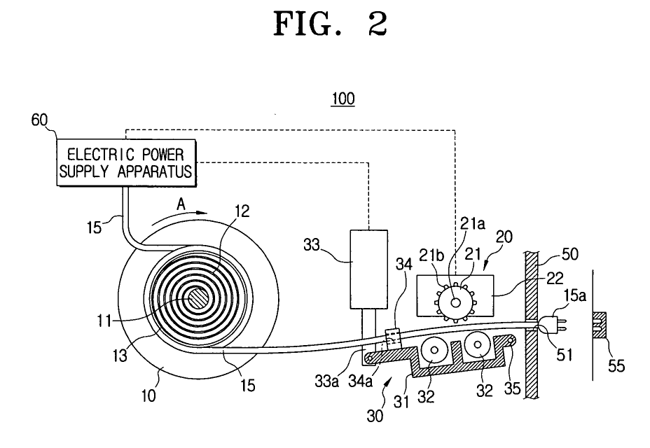

FIGS. 1 and 2 each illustrates a cord reel assembly according to an embodiment of the present disclosure.

As shown in FIGS. 1 and 2, a cord reel assembly 100 according to the present disclosure includes a cord reel 10 having a shaft II at a center thereof, a winding spring 12, and a winding part 13. The winding part 13 that a power cord 15 is wound around is disposed outside the shaft 11. The winding spring 12 such as a torsion spring, a spiral spring, and so on is disposed between the shaft 11 and the winding part 13. The winding spring 12 rotates the cord reel 10 in the direction of arrow A in FIG. 2 (namely, a winding direction of the power cord 15) due to the elastic force of the winding spring 12 so as to cause the power cord 15 to be wound around the winding part 13. In other words, the winding spring 12 applies an elastic force of a circumferential direction to the cord reel 10 in the winding direction of the power cord 15.

An end of the power cord 15 is electrically connected to an electric power supply apparatus 60 of the electronic device 50. A plug 15a is disposed at the other end of the power cord 15. The plug 15a is detachably connected to an electric outlet 55 of an external electric power source. When the plug 15a is inserted into the electric outlet 55, an external electric power is supplied to the electric power supply apparatus 60 of the electronic device 50 through the power cord 15.

The power cord 15 enters the interior of the electronic device 50, or is drawn out to the exterior of the electronic device 50 through a boring hole 51 formed at a side surface of the electronic device 50.

An unwinding unit 20 unwinding the power cord 15 wound around the cord reel 10 is disposed opposite the cord reel 10.

The unwinding unit 20 unwinds the power cord 15 wound around the cord reel 10 in an unwinding direction (in the direction of arrow B in FIG. 1), which is opposite to the winding direction (in the direction of arrow A in FIG. 2) so as to cause the power cord 15 to be drawn out to the exterior of the electronic device 50.

The unwinding unit 20 includes an unwinding roller 21 rotating in the unwinding direction B and a driving motor 22 causing the unwinding roller 21 to rotate.

The unwinding roller 21 rotates in contact with the power cord 15 in the unwinding direction B so as to unwind the power cord 15 from the cord reel 10.

A shaft 21a of the unwinding roller 21 is coupled to the driving motor 22, and the driving motor 22 is electrically connected to the electric power supply apparatus 60.

Also, a power transmitting mechanism (not shown) transmitting the power of the driving motor 22 to the unwinding roller 21 may be disposed between the driving motor 22 and the unwinding roller 21.

The unwinding roller 21 can include a friction structure 21b on the outer circumferential surface of the unwinding roller 21 touching the power cord 15 so as to increase the contacting force between the unwinding roller 21 and the power cord 15.

The friction structure 21b can be configured in various ways. For example, a friction material (not shown) such as rubber can be fixed on the outer circumferential surface of the unwinding roller 21. Alternately, a plurality of contacting projections 21b can formed on the outer circumferential surface of the unwinding roller 21 as shown in FIGS. 1 and 2.

A contacting unit 30 is disposed under the unwinding roller 21 so as to cause the power cord 15 to contact with the unwinding roller 21 and to keep in contact with the unwinding roller 21. The contacting unit 30 includes a pivot frame 31 configured to pivot on a pivot shaft 35 disposed at an end of the pivot frame 31, at least one guiding roller 32 rotatably disposed inside the pivot frame 31, and a linear motion member 33 pivoting the pivot frame 31 to touch the power cord 15 to the unwinding roller 21.

The at least one guiding roller 32 is, preferably, two guiding rollers 32 rotatably disposed inside the pivot frame 31 so as to support and guide the power cord 15.

The linear motion member 33 is electrically connected to the electric power supply apparatus 60, and has a moving part 33a connected to the other end of the pivot frame 31, that is, one end of the pivot frame 31 opposite the pivot shaft 35. The moving part 33a can move upward or downward once electric power is applied to the linear motion member 33.

In this embodiment of the present disclosure, the linear motion member 33 is configured as a solenoid so that, when the electric power is applied to the linear motion member 33, the magnetic force of an electromagnet disposed thereinside operates the moving part 33a to linearly move.

The pivot frame 31 further includes a guiding member 34 disposed nearby the other end of the pivot frame 31. The guiding member 34 has a guiding hole 34a through which the power cord 15 can be passed. The guiding hole 34a has a slightly larger diameter than the outer diameter of the power cord 15 so as to easily guide the power cord 15.

Hereinafter, operation of the cord reel assembly 100 according to an embodiment of the present disclosure will be explained in detail with reference to FIGS. 1 and 2.

When users insert the plug 15a of the power cord 15 into the electric outlet 55 of the external electric power source as shown in FIG. 1, the electric power is supplied to the electric power supply apparatus 60 via the power cord 15. The electric power supplied to the electric power supply apparatus 60 is used for the electronic device 50 to perform its original functions, and is simultaneously supplied to the unwinding unit 20 and the contacting unit 30.

When the electric power is applied to the linear motion member 33 of the contacting unit 30 via the electric power supply apparatus 60, the moving part 33a is moved upward by the attraction of the electromagnet. As a result, the pivot frame 31 is pivoted upward on the pivot shaft 35 so that the power cord 15 supported by the guiding roller 32 is in contact with the unwinding roller 21 of the unwinding unit 20.

At the same time, the electric power of the electric power supply apparatus 60 is applied to the driving motor 22 of the unwinding unit 20 so that the unwinding roller 21 rotates in the unwinding direction of the power cord 15 (in the direction of arrow B in FIG. 1) thereby automatically unwinding the power cord 15 from the winding part 13 of the cord reel 10.

When the users separate the plug 15a from the electric outlet 55 of the power source in order to stop the use of the electronic device 50 as shown in FIG. 2, the electric power is not supplied to the electric power supply apparatus 60. As a result, the unwinding unit 20 and the contacting unit 30 are not supplied with the electric power.

When the electric power is not supplied to the linear motion member 33 of the contacting unit 30, the moving part 33a of the linear motion member 33 moves downward so that the pivot frame 31 is pivoted downward on the pivot shaft 35. As a result, the power cord 15 is no longer in contact with the unwinding roller 21.

The electric power also is not supplied to the unwinding unit 20 so that the power cord 15 is automatically rewound around the winding part 13 of the cord reel 10 by the winding spring 12.

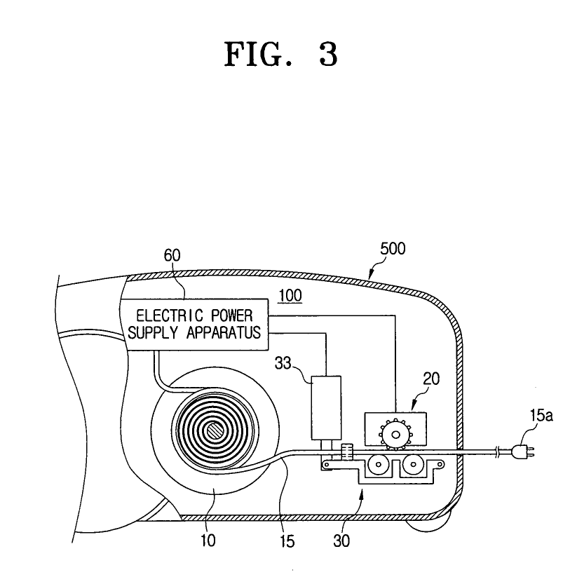

FIG. 3 illustrates the cord reel assembly 100 according to an embodiment of the present disclosure disposed in a vacuum cleaner 500.

With the vacuum cleaner 500 having the cord reel assembly 100 according to the present disclosure, winding and unwinding of the power cord 15 is easier than those of the conventional vacuum cleaner. Therefore, it is very convenient for users to use the vacuum cleaner 500.

The vacuum cleaner 500 is only one example of various electronic devices in which the cord reel assembly 100 according to the present disclosure can be used; however this should not be considered as limiting. The cord reel assembly 100 can be arranged in various electronic devices such as stoves, TVs, and so on.

While the embodiments of the present disclosure have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the disclosure.

What is claimed is:

1. A cord reel assembly comprising:
a power cord; and
a cord reel around which the power cord is automatically wound when the power cord is separated from an electric power source, the cord reel from which the power cord is automatically unwound when the power cord connected to the electric power source.

2. A cord reel assembly comprising:
a cord reel configured to wind a power cord connected to an electric power supply apparatus of an electronic device; and
an unwinding unit electrically connected to the electric power supply apparatus and unwinding the power cord from the cord reel.

3. The cord reel assembly of claim 2, wherein the cord reel comprises a winding spring rotating the cord reel in a winding direction of the power cord.

4. The cord reel assembly of claim 2, wherein the unwinding unit comprises:
a unwinding roller;
a driving motor rotating the unwinding roller in an unwinding direction of the power cord and electrically connected to the electric power supply apparatus.

5. The cord reel assembly of claim 4, wherein the unwinding roller further comprises a friction structure on an outer circumferential surface thereof.

6. The cord reel assembly of claim 5, wherein the friction structure comprises a friction material fixed on the outer circumferential surface of the unwinding roller.

7. The cord reel assembly of claim 5, wherein the friction structure comprises a plurality of contacting projections formed from the outer circumferential surface of the unwinding roller.

8. The cord reel assembly of claim 2, further comprises:
a contacting unit electrically connected to the electric power supply apparatus and forcing the power cord to be in contact with the unwinding unit.

9. The cord reel assembly of claim 8, wherein the contacting unit comprises:
a pivot frame configured to pivot on a pivot shaft;
at least one guiding roller rotatably disposed inside the pivot frame; and
a linear motion member configured to pivot the pivot frame about the pivot shaft so that the power cord is in contact with the unwinding roller.

10. The cord reel assembly of claim 9, wherein the linear motion member is electrically connected to the electric power supply apparatus, and has a moving part connected to the pivot frame,
wherein the moving part moves upward or downward when the electric power is applied to the linear motion member.

11. The cord reel assembly of claim 10, wherein the linear motion member comprises a solenoid having an electromagnet disposed thereinside and causing the moving part to linearly move by the attraction of the electromagnet.

12. The cord reel assembly of claim 9, wherein the pivot frame further comprises a guiding member with a guiding hole through which the power cord is passed.

13. A vacuum cleaner comprising:
a cord reel assembly comprising a cord reel around which a power cord is automatically wound when the power cord is separated from an electric power source, the cord reel from which the power cord is automatically unwound when the power cord is connected to the electric power source.
